(19) United States
(12) Patent Application Publication
(10) Pub. No.: US 2007/0146721 A1
(43) Pub. Date: Jun. 28, 2007

(54) System and method for measurement of optical parameters and characterization of multiport optical devices

(75) Inventors: Sergio Barcelos, Campinas (BR); Fafael Faraone Rando, Americana (BR); Nelson Kiyoshi Sasaki, Campinas (BR); Elso Luiz Rigon, Campinas (BR)

Correspondence Address: FELIX L. FISCHER, ATTORNEY AT LAW, 1607 MISSION DRIVE, SUITE 204, SOLVANG, CA, 93463, US

(73) Assignee: FIBER-WORK COMUNICACOES OPTICAS LTDA - ME, Campinas - SP (BR)

(21) Appl. No.: 10/596,101

(22) PCT Filed: Jan. 13, 2005
(86) PCT No.: PCT/BR05/00004

§ 371 Date: May 30, 2006

(30) Foreign Application Priority Data
Jan. 13, 2004 (BR) BR-PI-0400231-8

(51) Int. Cl. G01B 9/02

(52) U.S. Cl. 356/477

(57) ABSTRACT

System and method for measurement of optical parameters and characterization of multiport optical devices constituted by process control systems, one or more sources of optical test signal (11) (tunable laser source), optical circuit including optical fiber and several other optical components arranged so as to constitute an interferometric optical arrangement, optical connectors, optoeletronic interfaces, photodetectors, analogical electronic; circuits, digital electronic circuits for digital signal processing and electronic circuits for data acquisition, the test and reference optical signals traversing paths with any lengths, that can be identical or distinct, the optical signal traversing at least one of said paths of interferometer being phase- and/or frequency-modulated. The signals of both interferometer arms are summed at a same photodetector (26) that translates to the electric domain the heterodyning of the optic signals, which contain the information of the optical characteristics of the DUT (17) (device under test), the transfer of the optical signals between the diverse ports of the DUT being described by means of the Optical “S”-Parameters where each “Sxy” parameter is represented using the formalism of Jones (Jones matrix) and/or the formalism of Muller (Muller matrix) and where all the determinations of the optical characteristics of the DUT (17) (bandwidth, phase, time delay, chromatic dispersion, 2nd order chromatic dispersion, reflectance, reflection coefficient, transmittance of the port “y” to the port “x” and vice versa, transmission coefficient of the port “y” to the port “x” and vice versa, insertion loss, polarization dependent loss, polarization mode dispersion (DGD/PMD), 2nd order DGD, etc.) are based on said “Sxy” parameters.

### BACKGROUND OF THE INVENTION

The present invention relates to the interferometric measurement of optical devices parameters including the determination of the “S”-parameters of optical devices with one or more ports, in transmission and/or reflection.

“S”-Parameters are concepts widely used in the microwave engineering practice, which facilitate the analysis of the signal transfer between the ports of a multi-port device, therefore, its application is also feasible in optical device techniques. However, while based on similar principles, optical “S”-parameters differ substantially from microwave “S”-parameters due to the fact that the polarization characteristics of the light transmitted through the DUT (Device Under Test) must be taken into account. In the case of microwave “S”-parameters, each “S_{xy}” is a complex number that represents the characteristics of transmission and/or reflection from port Y to port X of the DUT. In the case of optical “S”-parameters, each “S_{xy}” it is represented using the Jones' formalism (Jones matrix) and/or the Müller's formalism (Müller matrix). From each “Sxy” it is possible to deduct all the usual optical properties for the characterization of photonic devices, such as: bandwidth, phase, time delay, chromatic dispersion, 2^{nd} order chromatic dispersion, reflectance, reflection coefficient, transmittance from port “y” to port “x” and vice-versa, transmission coefficient from port “y” to port “x” and vice-versa, insertion loss, polarization dependent loss, polarization mode dispersion DGD/PMD), 2^{nd} order DGD, etc.

### DESCRIPTION OF THE PREVIOUS ART

Optical components have become increasingly important in WDM systems (Wavelength Division Multiplexing), high capacity optical systems, all-optic communications systems, dispersion compensation, fiber sensing and other technologies. In the last twenty years, a significant amount of research has been focused on the development of optical devices equivalent to electronic components, in order to allow the development of all-optical networks and of the photonics field in general. The full utilization of the benefits of such devices, requires the accurate measurement of their optical characteristics, such as: bandwidth, phase, time delay, dispersion, reflectance, transmittance, insertion loss, polarization dependent loss, polarization mode dispersion etc. The optical characteristics of the DUT are generally defined for specific wavelengths, therefore, to extend these characteristics over a certain bandwidth, as it is normally the case, the characterization process should be repeated for a finite number of wavelengths, Several equipments, systems and methods have been proposed to avoid the need of conducting a great number of measurements in several wavelengths. One well-known process is the so-called “RF Phase Shift” technique. Such method of characterization of optical devices demands a set of expensive equipments and entails a trade-off between precision and resolution of wavelength.

Due to the above mentioned shortcoming, current solutions use interferometric techniques which have become more efficient, more accurate and less costly

One known system that employs an interferometric optical technique, is described in document EP 1182805. In this arrangement, a laser generator is swept in wavelength with a constant sweep speed, its signal being split into two arms, of necessarily different lengths, whith the DUT inserted in one of them. The signal transmitted through the “known” arm (called reference arm) and the one which traveled through the arm with the DUT (Device Under Test) are mixed in a photodetector, giving rise to an electric signal from the beating of the different frequencies of optical signals, the displacement between said frequencies being due to the propagation delay in the different signal paths. The resulting heterodyne (or quasi-homodyne) signal, ranging in frequency from some KHz to a few MHz, is directed to a signal processing system that determines the desired optical characteristics of the device. This procedure allows the translation of the information regarding the optical characteristics of the DUT from the optical to the electrical domain. For example, the instantaneous-wavelength-dependent coefficient of transmission is given by the instantaneous amplitude of the heterodyne electrical signal. A considerable disadvantage of this technique, called SWI (Swept Wavelength Interferometry), is the need to use only “swept” lasers, which aft continuously swept in wavelength. Another shortcoming is the fact that the lambda noise (wavelength) of the laser is amplified, due to the required large length imbalance of the interferometer arms.

### OBJECTS OF THE INVENTION

In view of the above, the first aim of the invention is to provide a system that allows the complete characterization of multi-port passive optical devices in a speedy manner, with the feature of being able to operate both in the continuous sweep swept mode or in the stepped swept modes of the tunable laser source.

It constitutes another purpose of the invention to furnish a system that provides great precision in the measurements of transmission coefficient, reflection coefficient, transmitance, reflectance, intrinsic loss, bandwidth, phase, time delay, chromatic dispersion, 2^{nd} order chromatic dispersion, differential group delay (DGD)/polarization mode dispersion, 2^{nd} order DGD, polarization dependent loss of optical devices, as well as providing high resolution in wavelength.

Yet another object is to provide a system where the effect of the mechanical vibrations is minimized.

Another additional object is to provide a system where the effect of the variations of ambient temperature is minimized.

Another object is to furnish a system and a method that allows the simultaneous determination of all the above mentioned optical characteristics in all the transmission directions of a multi-port DUT, with a single wavelength sweep of the tunable laser source.

### SUMMARY OF THE INVENTION

The above mentioned aims are attained by means of an interferometric optical arrangement in which the paths of the test signals (or DUT signals) and the reference signals has approximately equal lengths, without requiring any length imbalance in the arms of the interferometer.

According to another feature of the invention, the optical signal of at least one of the arms of the interferomneter is phase- or frequency-modulated.

In accordance with another feature of the invention, the optical phase or frequency modulator can be constructed by any known optical technologies.

In accordance with another feature of the invention, the optical arms of the interferometer can be constructed using different physical paths for propagation and conduction of the optical signal, such as: optical waveguides, planar waveguides, free space (FSO) etc.,

### BRIEF DESCRIPTION OF THE DRAWINGS

Additional advantages and features of the invention will be more easily understood through the description of some exemplary embodiments which exemplify the arrangements used in the diverse kinds of measurements as well as the operating principles of the system, together with the related figures, in which:

FIG. 1 shows the arrangement used in the measurement of the reflection parameters of a passive component with only one port, according to the invention.

FIG. 2 shows the arrangement used in the measurement of the transmission parameters of a passive component with two ports, according to the invention.

FIG. 3 illustrates an arrangement used for the partial characterization of a two-port DUT, simultaneously in transmission and reflection.

FIG. 4 shows an arrangement used in the simultaneous characterization of all ports, in transmission and reflection, of a two-port device.

FIGS. 5 to 8 illustrate the paths of the optical signals in the characterization of optical “S”-parameters, using the arrangement shown in the previous figure.

FIG. 9 illustrates a block diagram showing the operating principle for suppressing the effects of vibration and temperature changes,

FIG. 10 illustrates the arrangement used for the above mentioned suppression being applied to the optical circuitry shown in FIG. 2.

FIG. 11 illustrates the arrangement used for simultaneous measurement of the polarization characteristics in transmission and reflection of a 2-port DUT.

### DETAILED DESCRIPTION OF THE INVENTION

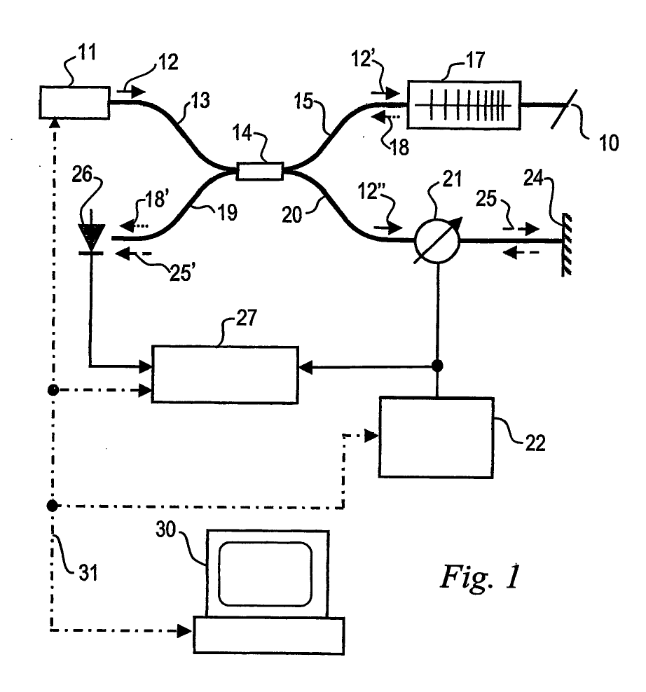

The invention now will be detailed through specific examples related to some typical applications. The first embodiment refers to an arrangement used for the characterization of the reflection parameters of a DUT. FIG. 1 illustrates relative positions of the elements used in the test, to wit;
a tunable laser signal source 11 (TLS—Laser Tunable Source), that is controlled by the control system 30;
an optical coupler 14;
a device under test 17 (DUT);
an optical modulator 21;
a signal generator 22;
an optical fiber mirror 24;
optical detection system 26
electronic system for data acquisition 27

The system shown in FIG. 1, whose optical part forms a Michelson interferometer, operates in the following way: the control system 30, which manages the optical characterization process, issues a command to TLS 11 to generate an optical signal 12. This signal is directed by the optical fiber 13 to the optical coupler 14, where it is split in two signals 12′ and 12″ that are directed, through optical fibers 15 and 20, to DUT 17 and optical modulator 21, respectively. The signal 12′ that impinges on the DUT can be transmitted or be reflected, depending of its wavelength and the specific optic characteristics of the DUT. The transmitted signal is absorbed at output device 10. The reflected signal 18 returns by the optical fiber 15 to coupler 14, where it is split again: part of it returns through optical fiber 13 and another part 18′, is transmitted by optical fiber 19. In turn, the signal 12″ passes though modulator 21, where it is modulated in phase or frequency by the modulating signal 23 provided by the signal generator 22. The modulated optical signal 25 is reflected by mirror 24 and passes again though the modulator 21, returning to optical fiber 20 and going to the coupler 14, where it is split. The portion 25′ of this modulated signal enters optical fiber 19, that also transmits signal 18′ to the optical detection system 26.

The optical detection system 26 produces the heterodyning between the two signals 18′ and 25′, translating information from the optical domain to the electrical domain, giving at its output, in addition to the original signals, the products of the heterodyning, particularly the difference signal. This is an electrical signal whose spectrum contains frequency components whose amplitude and phases depend on the modulating signal 23 and on the optical characteristics of the DUT. The data acquisition circuit 27 extracts information about the optical characteristics of the DUT from the electrical signal. This process of extraction of the information contained in the electric signal can be carried through using different techniques, such as filtering and direct detection, Lock-in, FFT (Fast Fourier Transform) etc, which can be implemented using analog techniques (analogic processing of signals), digital (digital processing of signals) and/or through software. The amplitude information extracted from the electric signal is proportional to the characteristic called “reflection coefficient” of DUT 17. This amplitude information enables the extraction of other information about the DUT, such as: reflectance, insertion loss, bandpass etc. The phase information extracted from the electric signal refers to the phase deviation introduced by the DUT in the reflected signal, allowing the acquisition of other information, such as: group delay, chromatic dispersion etc.

Besides registering the data about the reflection coefficient and phase deviation of the DUT, the control system manages the process, selecting the series of wavelengths, which must be sufficiently close so as to provide a good resolution in the determination of the DUT characterstics.

As already mentioned, the optical phase/frequency modulation uses any know technique of modulation, such as for example, changing the refraction index of an optical element, changes in the signal propagation length, electric-optic effects, etc. Amongst these, one exemplary embodiment uses a piezoelectric ceramic cylinder over which the optical fiber is wrapped. Applying the modulating signal to this cylinder, its dimensions change in accordance with this signal, stretching the optical fiber which changes its length as well as its refractive index, producing the phase modulation in the phase of the optical signal that traverses the fiber.

The optical modulator 21 doesn't have to be located in the reference arm of the interferometer. It can alternatively be located in the DUT arm or in both arms.

The system is not limited to the use of a saw-tooth modulating signal; other waveshapes can be used, such as square wave, sine wave, waves composed of linear segments etc.

One of the advantageous features of the invention is the fact that the system can work with laser sources in which the wavelength is continuously changed or where this wavelength is changed by steps (“Swept” and “Stepped” Lasers).

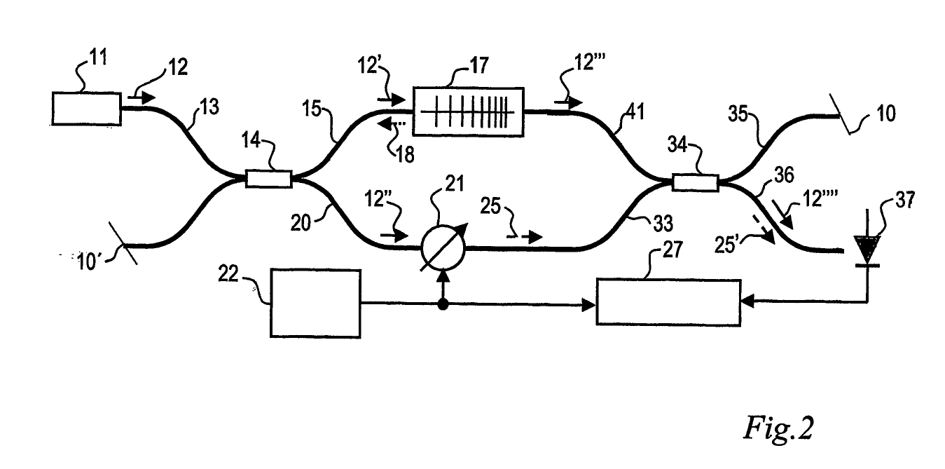

FIG. 2 illustrates the arrangement used in the measurement of the transmission characteristics of a DUT 17. For clearness sake, control lines 31 that connect the control system to TLS 11 and to the electronic acquisition circuitry 27 had been omitted in this figure, however such control exists in the same way as in the previous arrangement. In the arrangement of FIG. 2, whose optical part forms an Mach-Zehnder interferometer, the signal 12 generated by the laser 11 is conveyed by the optical fiber 13 to the coupler 14, where it splits into the signals 12′ and 12″. The first one of these is transmitted by optical fiber 15 to the DUT 17, where it can be reflected, spread, absorbed or even transmitted as signal 41, depending on the specific optical characteristics of the DUT. The signal 12″ is directed to modulator 21, where it is modulated by the signal provided by the signal generator 22, resulting in the phase- or frequency-modulated signal 25, that it is directed by the optical fiber 33 to a second coupler 34, where it is added to signal 41 transmitted through DUT 17. Part of these added signals, 25′ and 41′, is directed to the optical detection system 37, where the heterodyning between this signals occurs. In a similar way to that shown in the arrangement of FIG. 1, the signal difference is introduced in one of the inputs of the acquisition circuit 27, which receives in its other input the reference signal from the signal generator, that is used to determine the transmission characteristics of DUT 17. Devices 10 and 10′ are terminations that do not reflect the signal.

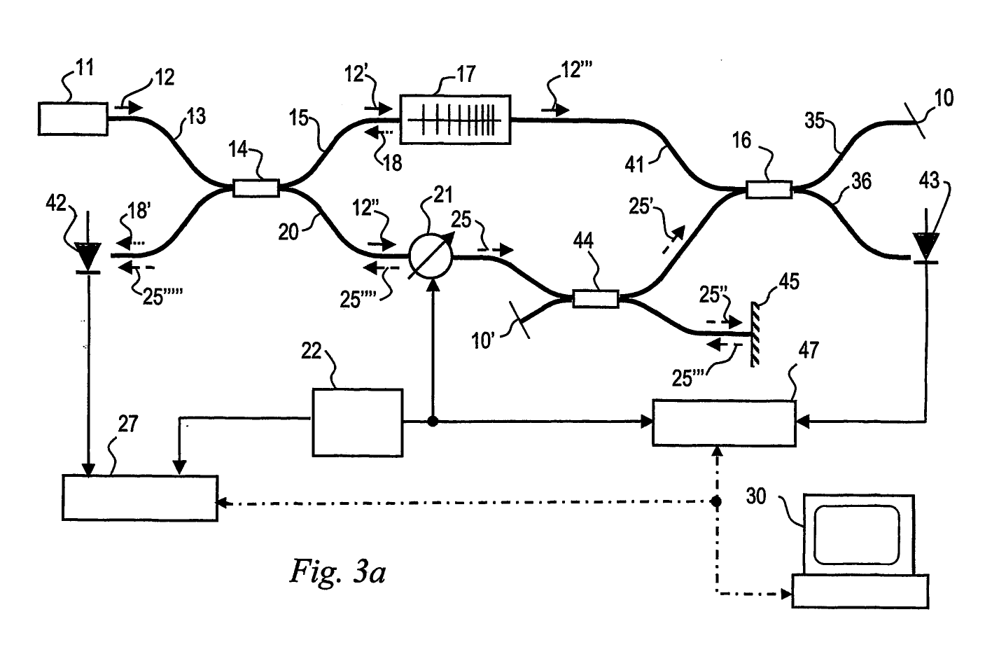

The FIG. 3a illustrates one of the arrangements that can be used for simultaneous characterization of the DUT in transmission and reflection. Signal 12 of laser 11 is introduced in the optical coupler 14, which splits it in two components 12′ and 12″, directed respectively, to DUT 17 and modulator 21, in which occurs the modulation in phase or frequency by the modulating signal generated by the signal generator 22. The modulated optical signal 25 is directed to the optical coupler 44, where it divides in two components 25′ and 25″, the first one being transmitted to the optical coupler 16 where it is added to the transmitted signal 41 through said DUT. This sum of signals is detected by the optical detection system 43 where the heterodyning between these signals occurs producing several other signals, that are directed to the first input of the acquisition circuit 47, including the difference signal (25′−41). This signal has a frequency spectrum that contains phase and amplitude information of the DUT for a determined wavelength. The second input of the acquisition circuit 47 receives the modulating signal proceeding from generator 22 to provide a phase and amplitude reference for the circuit operation. In the output 47, it is possible to get the information concerning the S₂₁ transmission parameter (transmission of port 1 to the port 2) of the DUT.

The second component 25″ of the modulated signal is reflected by mirror 45 and returns through coupler 44, modulator 21 and coupler 14, where it is added to signal 18 reflected by the DUT. These signals are directed to the optical detection system 42 whose output produces, among others, the difference signal (25′″″−18) that is inputted to the acquisition circuit 27 whose output has the information of amplitude and phase of the reflected signal, providing the characterization of the reflection parameter of the DUT (S₁₁).

This arrangement illustrated in the FIG. 3a can be interpreted as being equivalent to the overlapping of two optical interferometers, that can be better seen in FIGS. 3b and 3c. In the first one, the optical part forms an Michelson interferometer, composted by the segments of optical fiber 13, 15, 19, 20, 32 and 34, the mirror 45, couplers 44 and 14 and the optical modulator 21. FIG. 3c shows that the optical elements used in the measurement of the transmission characteristics of the DUT forms a Mach-Zehnder interferometer, composted by the optical fiber segments 13, 15, 20, 32, 33, 41, 35, 36 as well as couplers 14, 44, 16 and the optical modulator 21. It is seen that many elements of said interferometers are part of both devices. Such is the case of the optical fiber segments 13, 15, 20 and 32, as well as the couplers 14 and 44 and optical modulator 21. This overlapping—that is meant to provide the simultaneous measurement of two parameters of the DUT—is possible by using the optical modulation in phase or frequency of the reference signal, entailing the advantage of making the operation of the interferometers totally independent of the physical lengths of its interferometer arms.

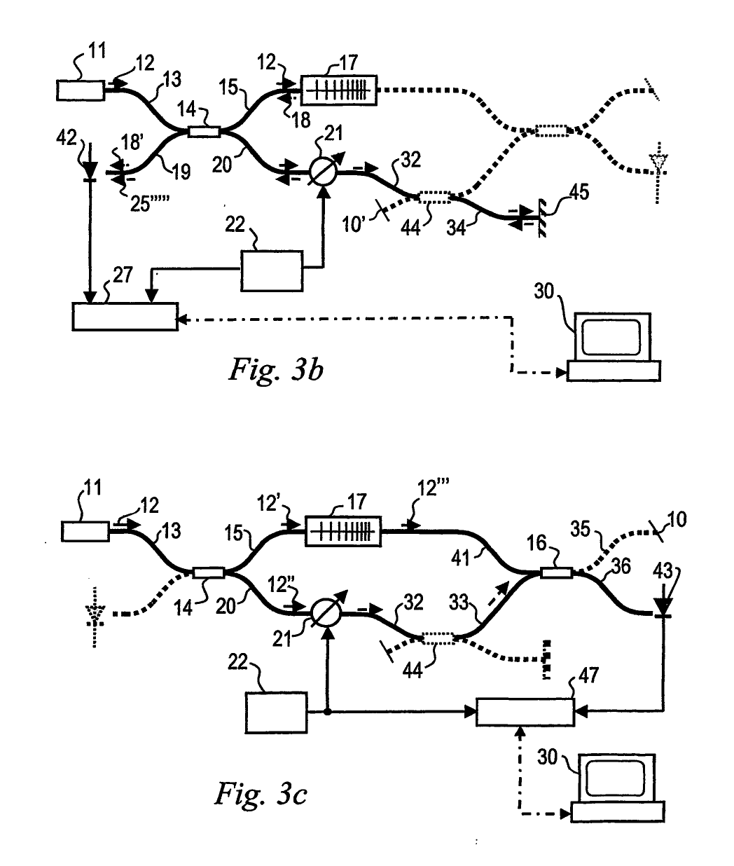

For characterization of the two other parameters S₁₂ and S₂₂ with the arrangement of the FIG. 3, it is necessary to invert the position of the DUT. For the concurrent of both ports of a two port device, simultaneously in transmission and reflection, the arrangement illustrated in FIG. 4 must be used. This simultaneous characterization refers to the determination of the reflection and transmission parameters of the two-port DUT in all directions of propagation (S₁₁, S₂₁, S₂₂ and S₁₂), in a single wavelength sweep. In this arrangement, two different modulating signals, whose frequencies ωₘ₁ and ωₘ₂, generated by generator 49 cannot be multiple or have coincident harmonics. In this figure, the electronic circuit that performs the treatment of the signals detected by the detection system 42 and 43 are grouped in blocks 50 and 50′, which are responsible for the acquisition of the parameters “S₁₁ and S₁₂” and “S₂₂ and S₂₁”, respectively.

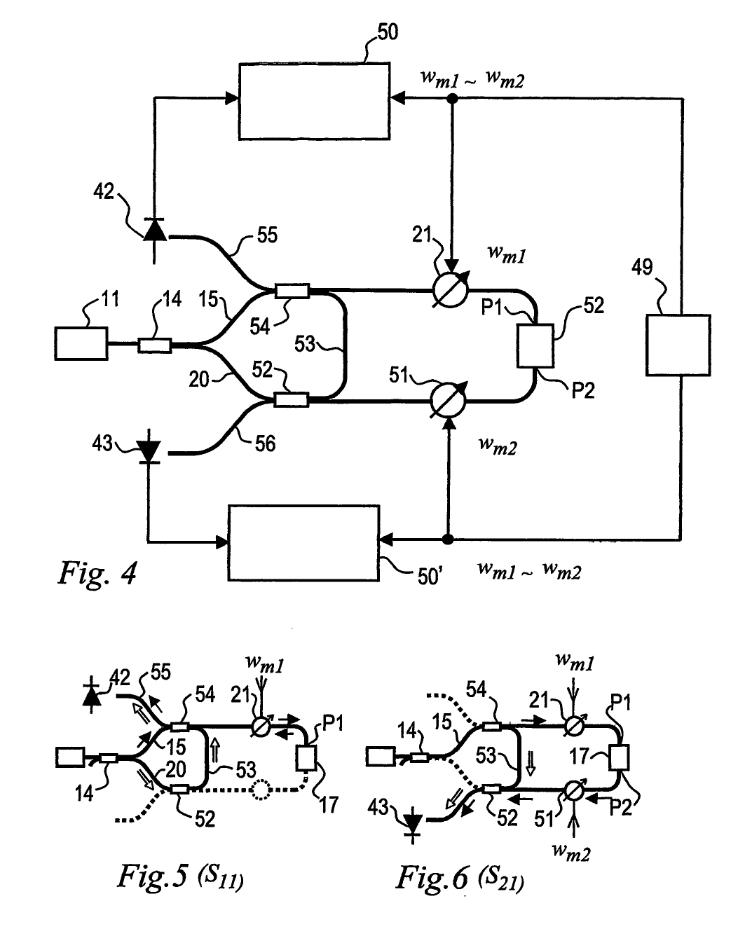

The FIG. 5 shows the paths of the optical signals in the characterization of the reflection parameters of port 1 (S₁₁). In this measurement, the signal generated by the laser is split by coupler 14 in two components, the first one being directed, through the optical fiber 15 and the coupler 54, to the modulator 21 where it is modulated in phase or frequency with the modulating signal with frequency ωₘ₁ and going from there to the P1 port of DUT 17. The second component traverses optical fiber 20 to coupler 52, which forwards part of this component through fiber 53 to coupler 54, where is added to the reflected signal from the DUT that returned through modulator 21. These added signals traverse optical fiber 55 to the optical detection system 42, the resulting electric signal of this detection being processed by block 50, which includes the acquisition circuitry to allows the characterization of the S₁₁ parameter.

The FIG. 6 shows the paths of the optical signals for the characterization of the S₂₁ parameter. In this case, the first component of the signal produced by the laser is directed through the optical fiber 15 to coupler 54, where it is split: part of this signal goes to the phase or frequency modulator 21, where is modulated by the modulating signal with frequency ωₘ₁ and traverses DUT 17, in the direction from the P1 port to the P2 port, as well as to modulator 51 where it is modulated by the modulating signal with frequency ωₘ₂ and forwarded to coupler 52, where it is added to the unmodulated signal that arrives from optical fiber 53. The detection, by the optical detection system 43, of these added signals produces the difference signal that will be treated by the electronics circuitry 50′, enabling the determination of the S₂₁ parameter associated with the transmittance of DUT 17, in the direction of port P1 port to port P2.

The paths of the optical signals in the characterization of the reflection parameters in port 2 (S₂₂) are illustrated in the FIG. 7. In this measurement, the optical signal generated by the laser is split by the coupler 14 in two components, the second one being directed, through the optical fiber 20 and coupler 52, to the modulator 51 where is modulated in phase or frequency by the modulating signal with frequency ωₘ₂ and from there to the P2 port of DUT 17. The first component leaves coupler 14, traverses optical fiber 15 to coupler 54, that sends part of this component through fiber 53 to the coupler 52, where is added to the signal reflected by the DUT returned thorough modulator 51. These summed signals traverse optical fiber 56 to the optical detection system 43, the resultant electric signal of this detection being processed by the block 50′ that supplies the data for the characterization of the S₂₂ parameter.

The FIG. 8 depicts the paths of the optical signals for the characterization of S₁₂. In this case, the second signal component produced by the laser is transmitted through optical fiber 20 to coupler 52, where it is split. One part of this signal is modulated in phase or frequency by the optical modulator 51 with frequency ωₘ₂ then traverses the DUT 17, in the direction of port P2 to port P1, further traversing modulator 21 where this signal is modulated by the frequency ωₘ₁ being directed from there to coupler 54, where it is added to the unmodulated signal from the optical fiber 53. The detection of the summed signals by the optical detection system 42 produces the signal difference that will be processed by block 50, enabling the determination of the S₁₂ parameter associated with the transmittance of DUT 17 in the direction of port 2 to port 1.

As occurs in the arrangement of the FIG. 3, the present disposition also is equivalent to the overlapping of diverse optical interferometers, that share the same segments of optical fibers. Thus, in FIGS. 5 and 7, both Michelson interferometers have in common the ring formed by the segments of optical fibers 15, 20 and 53, as well as couplers 14, 52 and 54. In the arrangements of FIGS. 6 and 8, the Mach-Zehnder interferometers share the optical fibers segments 53, as well as the path that goes from coupler 54, passing by the modulator 21, the DUT 17 and the modulator 51 to the coupler 52.

The arrangement shown uses only two optical detection systems—42 and 43—each one receiving the signals related to two parameters: the signals that allow the determination of the parameters S₁₁ and S₁₂ are received simultaneously by system 42, and the ones referring to the parameters S₂₁ and S₂₂ are received simultaneously by the optical detection system 43. The discrimination between signals that arrive at the same detection system is possible by the different modulations applied to these signals. Thus, the signal used for determination of S₁₁ is modulated by the frequency ωₘ₁ (as shown in FIG. 5) while the signal that allows the determination of S12 is modulated by the frequencies ωₘ₂ (as shown in FIG. 8). In general, the electronic acquisition circuits select information in the frequencies of interest, allowing the discrimination of the different S_{xy} parameters, even when they are received by the same optical detection system, because these information are individualized by the modulating signals.

According to the invention, the measurements of the characteristics of the DUT's are reached by optical interferometry, in which the light signals propagate between two different paths or arms and are later recombined. The results of these measurements are influenced by any changes occurring in these paths, such as, for example, the refractive index of the fiber, the physical distance covered by the light etc. Thermal variations and mechanical vibrations can stretch the optical fiber or modify its refraction index, affecting differently the two arms of the interferometer and, consequently, introducing detrimental variations in the output signals of the interferometer.

The changes in the properties of the optical paths are neutralized in the present invention by means of an active control of the changes in the optical system, which compensates the errors due to thermal variations and/or mechanical vibrations. This device consists of the virtual duplication of the interferometer, making it to operate in two distinct wavelengths. A first group of wavelengths is used to characterize the DUT. A second and fixed wavelength allows the evaluation of the variations that occurring in the interferometer due to variation of temperature and/or mechanical vibrations and feeding back the system with a correction signal that is applied to the interferometer that characterizes the DUT.

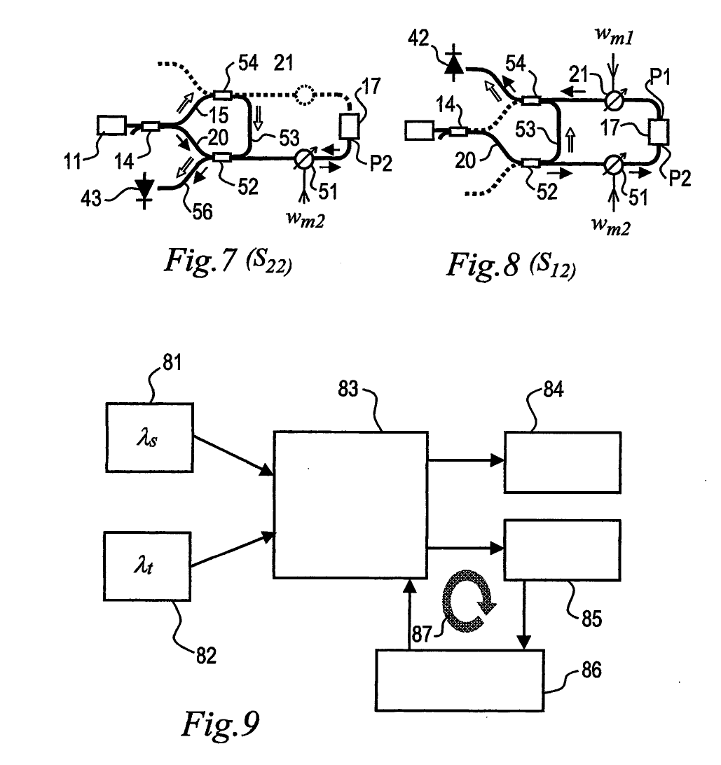

The block diagram that shows the working principle of the temperature compensation is depicted in FIG. 9. As illustrated, two sources of laser light are used, the first one 81 generating the signal in variable wavelengths λ_{S} for DUT test, and the second 82 generating a ted wavelength signal λ_{T} for the control and compensation of vibrations and temperature changes. Both signals are introduced in interferometer 83. At the interferometer output there are two optical detection systems, the first one 84 being the optical detection system for characterization of the DUT and the second, 85, for the monitoring signal λ_{T}. This second optical detection system feeds a comparator and error signal generator block 86. The interferometer receives a negative error signal feedback through the optical modulators. If a variation in the system produced by thermal variation or mechanical vibration occurs, this will be compensated by the feedback link 87, and it will not affect the measurement results.

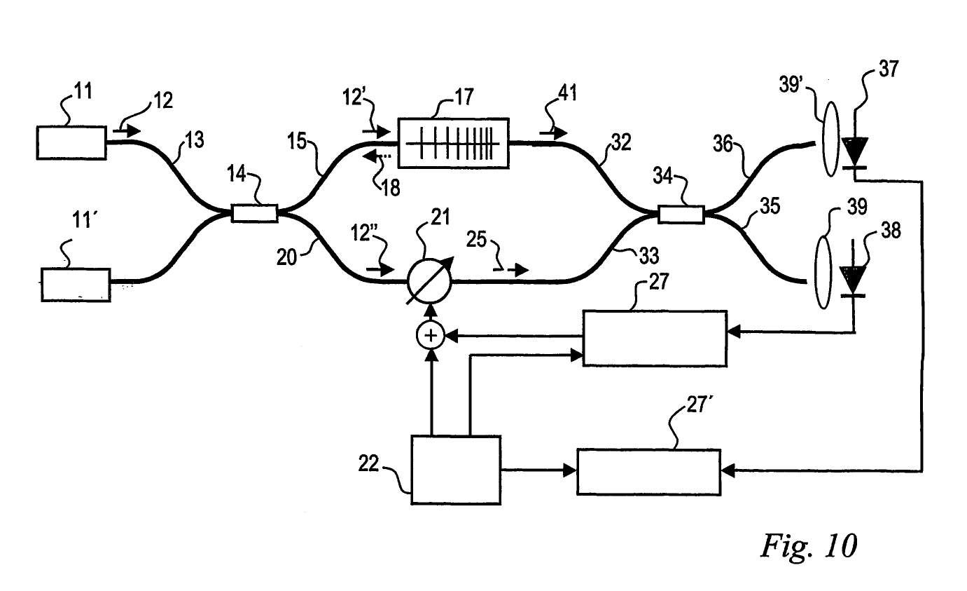

FIG. 10 illustrates the system of temperature compensation in a more detailed form. In this diagram, two laser generators are used, the first 11 producing the test signal (variable wavelength) and the second 11′ producing the compensation signal (fixed wavelength λ_{T} falling outside the test signal wavelength). These signals are added in coupler 14, being split in two components that are transmitted by the optical fibers 15 and 20. Signal 41 that traversed the DUT is split again by coupler 34 and arrives through the fibers 35 and 36 at the two optical reception systems 37 and 38. The signal 12″ traverses modulator 21 and is also split by coupler 34 following by fibers 35 and 36 to the optical reception systems 37 and 38. The optical reception system 38 has a selective filter 39 tuned to the control wavelength. Therefore, the signal produced by photo detection system 38 is only related to the control wavelength. The temperature compensation signal is directed to the block 27′, which consists of an electronic circuit similar to that used in the treatment of the measurement signals. As the optical paths are fixed for λ_{T} and the control light source also operates in a fixed wavelength, the photodetected signal should not suffer a phase change. In case that some change of phase occurs, this will have been caused by thermal or mechanical disturbances, and can be compensated in the modulators. As the response of the optic system λ_{T} is almost identical for the control and measure wavelengths, the compensation also occurs in the wavelength band of the test device. Thus, the optical interferometer setup formed by the acquisition circuit associated to the optical detection systems 38 allows to obtain the error signal that will be negatively fed back to the interferometer through the existing optical phase modulators. On the other hand, the elements associated with the optical detection systems 37, the selective filter 39′ for test wavelengths and the acquisition circuit 27 operate in the characterization of the DUT like the previously detailed arrangement of FIG. 2.

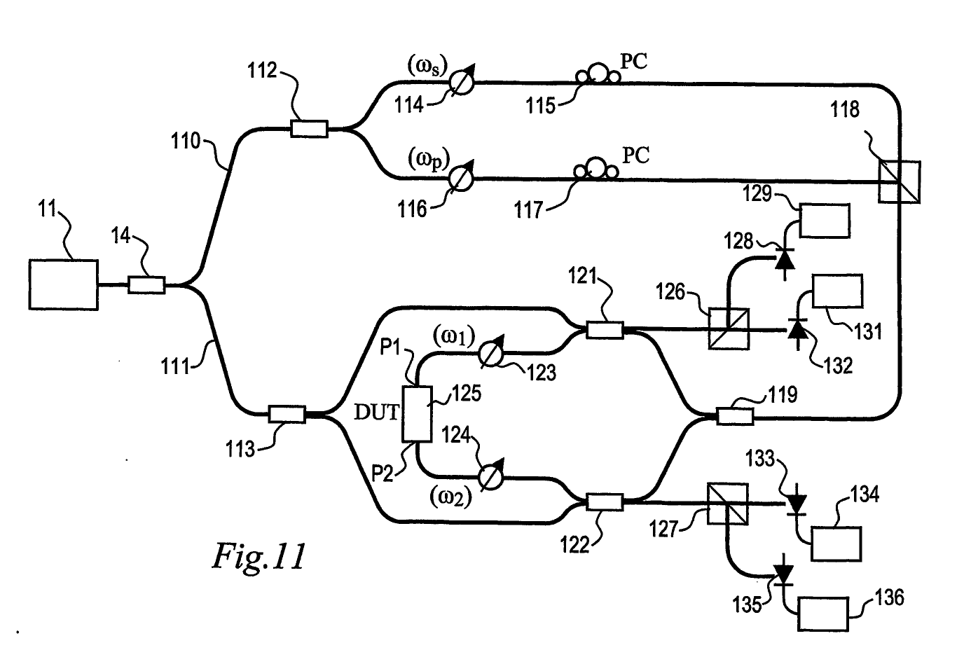

FIG. 11 shows the device configuration that allows the simultaneous determination of the polarization characteristics of the DUT for two orthogonally polarized light waves. The test signal generated by the tunable laser 11 is split by coupler 14 in two components and directed by the optical fibers 110 and 111 to couplers 112 and 113 where they are split again. The sub-components derived from coupler 112 are modulated in phase or frequency by the modulators 114 and 116 with modulating signals ωₛ and ωp. The modulated signals are processed by the polarization controllers (PC) 115 and 117, which maximize the orthogonal polarization components of light s and p, respectively. These signals are summed in the polarization combiner (PBC—Polarization Beam Combiner) 118, that guarantees the orthogonality between both and then directed to coupler 119, where the sum of the signals is split in two components, directed through couplers 121 and 122 to DUT 125. In this path, each component of the sum of the signals is modulated by the modulating signals ω₁ and ω₂. Part of these components traverse DUT 125 and part are reflected by it. Each one of these parts undergo then a second modulation by the modulating signals ω₁ or ω₂, as the case be. The resultant signals are then diverted by couplers 121 and 122 and directed to the Polarization Beam Splitter (PBS) 126 and 127 and from there to the optical detection systems 128, 132, 133 and 135, followed by the processing and acquisition systems. The modulations suffered by the optical signal during its passage through the modulators allow to identify the individual polarization components in quadrature, allowing the determination of the DUT polarization characteristics. For example, the optical signal that arrives at the optical detection system 128 is modulated by the following frequencies, related to the transmission through the DUT:
ωₛ+ω₂+ω₁
ωₚ+ω₂+ω₁
ωₛ−ωₚ+ω₂+ω₁

As concerns the reflected signal, the optical signals that arrive at the optical detection system 128 are modulated by the following frequencies:
ωₛ+2 ω₁
ωₚ+2 ω₁
ωₛ−ωₚ+ω₁

These 6 signals can be electronically separated and can be individually analyzed by the electronic circuits.

The electronic circuit 129, the optical detection system 128, the circuit 131 associated to the optical detection system 132 form a polarization diversity receiver, capable of extracting the amplitude and phase information of the components and allowing the selective optical characterization of the S₁₁ and S₁₂ parameters The other optical detection systems and the associated circuitry operate in a similar way, providing the selective polarization characterization of all parameters of the DUT, namely S₁₁, S₁₂, S₂₂ and S₂₁. Dedicated computational algorithms correlate the information acquired by the electronic circuits 129, 131, 134 and 136 and allow the complete characterization of the DUT, as well as the polarization characteristics of the device, the whole process being carried out simultaneously in a single wavelength sweep of the Tunable Laser Source.

The measurement technique described previously exemplifies the characterization of two-port optical devices, generating 4 optical “S”-parameters (two of reflection and two of transmission). This concept may be extended, without any loss of generality, to the characterization of N-ports devices. In this case, taking the most complete version (FIG. 11) the setup “DUT+modulators” (123, 124 and 125) is substituted by a DUT of N ports (N=3, 4, 5 . . . ) where in each port is inserted an optical modulator whose frequency is distinct and not multiple of the remaining ones. Optical couplers sum all these signals proceeding from the diverse ports of the DUT forwarding these to the couplers 121 and 122, which transmit said summed test signals as well as the reference signal to the optical detection system, where the heterodyning occurs. In this way, a plurality of electrical signals is generated in the optical detection system that contains information of amplitude and phase of the combination of all the DUT ports, each one centered in a specific modulating frequency.

1. SYSTEM FOR MEASUREMENT OF OPTICAL PARAMETERS AND CHARACTERIZATION OF MULTIPORT OPTICAL DEVICES constituted by process control systems, one or more sources of optical test signal (tunable laser source), optical circuit including optical fiber and several other optical components arranged so as to constitute an interferometric optical arrangement, optical connectors, optoeletronic interfaces, photodetectors, analogical electronic circuits, digital electronic circuits for digital signal processing and electronic circuits for data acquisition, characterized by the fact that the test and reference optical signals traverse paths with any lengths, that can be identical or distinct, the optical signal traversing at least one of said paths of interferometer being phase- and/or frequency-modulated.

2. METHOD FOR MEASUREMENT OF OPTICAL PARAMETERS AND CHARACTERIZATION OF MULTIPORT OPTICAL DEVICES based in optical interferometry concept, using two optical paths in which in one of these the device under test (DUT) is inserted, and in which one or more optical phase/frequency modulators are inserted, characterized by the fact that the signals of both arms are summed at a same photodetector that translates to the electric domain the heterodyning of the optic signals, which contain the information of the optical characteristics of the DUT.

3. METHOD FOR MEASUREMENT OF OPTICAL PARAMETERS AND CHARACTERIZATION OF MULTIPORT OPTICAL DEVICES as claimed in claim 2, characterized by the fact that the system operates equally well with continuous wavelength sweeping as with step wavelength sweeping of the tunable laser source.

4. METHOD FOR MEASUREMENT OF OPTICAL PARAMETERS AND CHARACTERIZATION OF MULTIPORT OPTICAL DEVICES as claimed in claim 2, characterized by the capability of simultaneous interferometric characterization in reflection and transmission of all ports of multi-port optical devices using phase and/or frequency optical modulators in the arms of the interferometer,

5. METHOD FOR MEASUREMENT OF OPTICAL PARAMETERS AND CHARACTERIZATION OF MULTIPORT OPTICAL DEVICES as claimed in claim 4, characterized by the capability of determininig the polarization characteristics of the DUT for the two ortogonal polarization modes of light, the polarization discrimination being provided by distinct phase and/or frequency modulators installed in the interferometer arms.

6. METHOD FOR MEASUREMENT OF OPTICAL PARAMETERS AND CHARACTERIZATION OF MULTIPORT OPTICAL DEVICES as claimed in claim 2, characterized by the fact that the transfer of the optical signals between the diverse ports of the DUT is described by means of the Optical “S”-Parameters where each “_{xy}” parameter is represented using the formalism of Jones (Jones matrix) and/or the formalism of Müller (Müller matrix) and where all the determinations of the optical characteristics of the DUT (bandwidth, phase, time delay, chromatic dispersion, 2^{nd} order chromatic dispersion, reflectance, reflection coefficient, transmittance of the port “y” to the port “x” and vice versa, transmission coefficient of the port “y” to the port “x” and vice versa, insertion loss, polarization dependent loss, polarization mode dispersion (DGD/PMD), 2^{nd} order DGD, etc.) are based on said “S_{xy}” parameters.

7. METHOD FOR MEASUREMENT OF OPTICAL PARAMETERS AND CHARACTERIZATION OF MULTIPORT OPTICAL DEVICES as claimed in claim 4, characterized by the fact of the measurement of the different optical parameters in the different propagation paths is furnished by the arrangement of the optical interferometric circuits according to different optical configurations, each individual configuration corresponding to the measurement of a specific optical “S”-parameter of interest.

8. METHOD FOR MEASUREMENT OF OPTICAL PARAMETERS AND CHARACTERIZATION OF MULTIPORT OPTICAL DEVICES as claimed in claim 7, characterized by the fact of the optical interferometric circuitry is equivalent to the overlapping several individual optical configurations related to the simultaneous measurement of several optical “S”-parameters.

9. METHOD FOR MEASUREMENT OF OPTICAL PARAMETERS AND CHARACTERIZATION OF MULTIPORT OPTICAL DEVICES as claimed in claim 4, characterized by the fact that the complete determination of the transference matrix (“S”-parameter matrix) of multi-port optical devices is based on the concurrent use of optical techniques (interferometry, polarization diversity, phase and/or frequency optical modulation, optical beam coupling and division, generation of optical signal, signal beating, photodetection etc.), usual analogical and digital electronics techniques (generation of modulating signals, amplification, analogical filtering, digital filtering, “analogical Lock-in” technique, digital “lock-in” technique, analogical signal processing, digital signal processing, FFT techniques—“Fast Fourier Transform”, digital communication etc.) and specific software (software for data acquisition, data analysis, processing of results, graphic user interface software etc.).

10. METHOD FOR MEASUREMENT OF OPTICAL PARAMETERS AND CHARACTERIZATION OF MULTIPORT OPTICAL DEVICES as claimed in claim 4, characterized by the fact of the interferometric optical circuits stabilization against thermal variations or mechanical vibration is provided by means of the use of a second interferometer operating within the optical test circuits, functioning in a wavelength falling outside the test wavelength band, operating according to the WDM (wavelength division multiplexing) techniques.

11. SYSTEM FOR MEASUREMENT OF OPTICAL PARAMETERS AND CHARACTERIZATION OF MULTIPORT OPTICAL DEVICES as claimed in claim 1, characterized by the fact of the optical interferometer can be comprise different physical paths for propagation and conduction of the optical signal, such as: optical fibers, planar waveguides, free space (FSO) etc.

12. SYSTEM FOR MEASUREMENT OF OPTICAL PARAMETERS AND CHARACTERIZATION OF MULTIPORT OPTICAL DEVICES as claimed in claims 1 or 10, characterized by the use of optical phase and/or frequency modulators in the arms of the interferometer, said modulators being constructed according to using any known possible technologies, such as techniques of refractive index change, acusto-optic effect in crystals, length propagation changes, electron-optic effect etc.
